(19) United States
(12) Patent Application Publication
(10) Pub. No.: US 2015/0144506 A1
(43) Pub. Date: May 28, 2015

(54) SYSTEM, METHOD AND DEVICE FOR ANALYSIS OF CARBOHYDRATES

(71) Applicant: ARIZONA BOARD OF REGENTS on behalf of ARIZONA STATE UNIVERSITY, Scottsdale, AZ (US)

(72) Inventors: Stuart Lindsay, Phoenix, AZ (US); Peiming Zhang, Gilbert, AZ (US); Hao Liu, Tempe, AZ (US)

(73) Assignee: ARIZONA BOARD OF REGENTS on behalf of ARIZONA STATE UNIVERSITY, Scottsdale, AZ (US)

(21) Appl. No.: 14/401,343

(22) PCT Filed: Mar. 15, 2013
(86) PCT No.: PCT/US13/32113

§ 371 Date: Nov. 14, 2014

Related U.S. Application Data
(60) Provisional application No. 61/654,478, filed on Jun. 1, 2012.

(51) Int. Cl. G01N 27/26

(52) U.S. Cl. CPC G01N 27/26
USPC 205/782; 204/400; 204/406

(57) ABSTRACT

Embodiments of the present disclosure are directed to recognition tunneling methods, systems and devices for the detection of carbohydrates by measuring tunneling currents of sugars which give distinct electronic signals in a tunnel gap functionalized respectively with, for example, in some embodiments, 4(5)-(2-mercaptoethyl)-1H imideazole-2-carboxamide and 4-mercaptophenylboronic acid molecules on at least one, and preferably each electrode.

### RELATED APPLICATIONS

This application claims benefit under 35 USC 119(e) of U.S. provisional patent application Nos. 61/654,478, filed Jun. 1, 2012, and entitled, “System, Method and Device for Analysis of Carbohydrates,” the entire disclosure of which is herein incorporated by reference in its entirety.

### STATEMENT REGARDING FEDERALLY SPONSORED RESEARCH & DEVELOPMENT

Inventions disclosed herein were made with government support under NIH Grant No. RO1HG006323, awarded by the National Institute of Health. The U.S. Government has certain rights in inventions.

### FIELD OF THE DISCLOSURE

Embodiments of the present disclosure relate to detecting and/or otherwise identifying molecules, by means of, for example, electronic detection via recognition tunneling, one or more carbohydrates by measuring tunneling currents of sugars which give distinct electronic signals in a tunnel gap.

### BACKGROUND OF THE DISCLOSURE

Glycans are major players in numerous biological processes, including developmental biology, the immune response and inflammatory disease, cell proliferation and apoptosis, the pathogenesis of infectious agents including prions, viruses, and bacteria, and a wide range of diseases ranging from rare congenital disorders to diabetes and cancer. A simple carbohydrate molecule composed of five monosaccharides could have billions of different possible sequences. The incredible complexity provides a research challenge in urgent need of molecular tools for analysis of carbohydrates.

Mass spectrometry is one of the most commonly used techniques,² by which the first glycosaminoglycan sequence can be determined.³ However, glycomic analysis by mass spectrometry presents an inherently great challenge. The structural variations in glycan linkages coupled with the identical mass of epimeric monosaccharides make identification of glycan structures difficult.

High Performance Liquid Chromatography (HPLC) is another alternative for glycomic analysis based on separation of oligosaccharides.⁴ This technique relies on the unique chemistry of carbohydrates to label and visualize their separation. However, a caveat to this method is that the HPLC profiles can contain multiple glycans in each peak, and thus, changes in the HPLC profiles are difficult to interpret at the level of individual glycan structures.

### SUMMARY OF THE DISCLOSURE

This teachings of this disclosure are a further application and development of previous series of disclosures on readout systems, including, for example PCT publication nos. WO2008/124706A2, WO2009/117517, WO02009/117522A2, WO2010/042514A1, WO2011/097171, US2012/0288948, US publication no. 2012/0288948, and U.S. provisional Nos. 61/620,167, 61/593,552, and 61/647,847, based on the distinct tunneling signals generated when an analyte is trapped by molecules chemically tethered to two closely spaced electrodes via a mechanism called “Recognition Tunneling”, the noted disclosures of which are all herein incorporated by reference in their entireties.

In some embodiments of the present disclosure, the utilization of recognition tunneling (including, in some embodiments, systems and apparatuses disclosed in the noted applications) for detection of carbohydrates is provided. In some embodiments, such detection of carbohydrates is effected by measuring tunneling currents of sugars, which yield distinct electronic signals in a tunnel gap of such recognized tunneling systems. In some embodiments, this is readily accomplished with such systems having one or more electrodes, and in some embodiments, at least two electrodes functionalized respectively with, for example, 4(5)-(2-mercaptoethyl)-1H imideazole-2-carboxamide and 4-mercaptophenylboronic acid molecules.

Accordingly, in some embodiments, a device for detecting and/or otherwise identifying one or more carbohydrates is provided and may comprise two opposed electrodes, where each of the electrodes (or at least one) may be functionalized with a molecule that is bonded to the electrodes, and where the molecule forms non-covalent bonds with target carbohydrate residues. The device may also include voltage applying means (e.g., power supply, which may be computer controlled) for applying a voltage between the two electrodes, and current detecting means (well known in the art) for detecting a current passing between the two electrodes, where a detected current comprises a signal. The device may also include translating means for translating characteristics of each signal into corresponding structures of one or more carbohydrates as they pass between said electrodes. For example, in some embodiments, the electrodes may be incorporated into a nanopore that separates two reservoirs of electrolyte, ionic current being passed through the pore by means of biased reference electrodes, one in the chamber of each side of the pore. Charged sugars, such as those bearing a carboxylate, phosphate or amine may then be drawn through the nanopore by electrophoresis (according to some embodiments). In some embodiments, it will be appreciated by one of skill in the art that in some cases, even neutral molecules (as is the case for many sugars) may be drawn through the pore (e.g., if the walls are charged, as it the case for silicon nitride) by electroosmotic flow (see Keyser, U. Controlling molecular transport through nanopores. J. Roy. Soc. Interface 8, 1369-1378 (2011).)

One of skill in the art will recognize that modern computer controlled equipment can be configured with appropriate structure for supplying voltages and monitoring current, as well as collecting and storing data produced from runs of carbohydrates through detecting/sequencing devices/systems taught by the present disclosure.

In some embodiments, a method for detecting and/or otherwise identifying one or more carbohydrates is provided. The method may comprise at least one of the following steps, and in some embodiments, a plurality of such steps, and in some embodiments, all of the following steps. Specifically, the method may include providing a recognition tunneling apparatus. Such an apparatus may comprise two opposed electrodes, where each of the electrodes may be functionalized with a molecule that is bonded to the electrodes. In some embodiments, the molecule forms non-covalent bonds with target carbohydrate (e.g., residues). The apparatus for the method may also include voltage applying means for applying a voltage between the two electrodes, current detecting means for detecting a current passing between the two electrodes, wherein a detected current comprises a signal, and translating means for translating characteristics of each signal into corresponding structures of one or more carbohydrates as they pass between the electrodes. The method may further include flowing a fluid containing at least one carbohydrate between the two electrodes, where fluid flow is accomplished via at least one of a pressure gradient, electroosmosis, and electrophoresis. In some embodiments, signals are generated as the fluid flows through the gap which is representative of the at least one carbohydrate. The method may further include determining the at least carbohydrate based on the signals.

In some embodiments, the functionalized molecule used in the device (according to some embodiments) for detecting or otherwise identifying a carbohydrate is 4(5)-(2-mercaptoethyl)-1H imideazole-2-carboxamide. In some embodiments, the molecule is mercaptophenylboronic acid. In some embodiments, the molecule is any molecule containing carboxamide.

In some embodiments, a device for identifying carbohydrates is provided, where the device may comprise means for detecting electronic signals from individual molecules by measuring current signals as a voltage is applied across a junction in which the molecules are transiently trapped, means for recording said electronic signals and parameterizing the current as a function of time and means for identifying the electronic signals based on training a machine-learning program.

In some embodiments, the carbohydrates are isobaric isomers.

In some embodiments, a computer system for detecting and/or otherwise identifying at least one carbohydrate is provided, the system comprising at least one processor, where the processor includes computer instructions operating thereon for performing any of the methods taught by the present disclosure. For example, for performing a method for detecting and/or otherwise identifying one or more carbohydrates. Similarly, some embodiments of the present disclosure include a computer program for detecting and/or identifying at least one carbohydrate, the program comprising computer instructions for operation on a computer for performing any such methods taught by the present disclosure. Furthermore, some embodiments include a computer readable medium containing a program, where the program includes computer instructions for operation on a computer for performing any method taught by the present disclosure.

In some embodiments, a method for detecting, sequencing and/or otherwise identifying one or more carbohydrates is provided, wherein the method includes one or more of the following steps (in some embodiments, a plurality of the steps, and in some embodiments, all of the following steps): providing a recognition tunneling device, flowing a fluid containing one or more carbohydrates between two electrodes of the recognition tunneling device, where fluid flow is accomplished via at least one of a pressure gradient, electroosmosis, and electrophoresis, recording current signals generated as the fluid flows through the gap which is representative of the at least carbohydrates, and determining the one or more carbohydrates based on the signals. In some embodiments, the recognition tunneling device may comprise two opposed electrodes, where each of the electrodes (in some embodiments, at least a portion of at least one electrode) may be functionalized with a molecule that is bonded to the electrodes, and where the molecule forms non-covalent bonds with a target carbohydrate. The device may also include voltage applying means for applying a voltage between the two electrodes and current detecting means for detecting a current passing between the two electrodes, where a detected current comprises a signal. The device may additionally include translating means for translating characteristics of each signal into corresponding structures of one or more carbohydrates as they pass between said electrodes.

In some embodiments, the determining step may comprise comparing collected current signals of the flow to signature signals for specific carbohydrates. The determining step may also include algorithms for sorting through the collected signal data to eliminate background signals and the like.

The above-noted embodiments, as well as other embodiments, will become even more evident with reference to the following detailed description and associated drawings, a brief description of which is provided below.

### BRIEF DESCRIPTION OF THE DRAWINGS

FIG. 1a is an exemplary device for detecting, sequencing, and/or otherwise identifying one or more carbohydrates, according to some embodiments of the present disclosure.

FIG. 1b is the structure of representative molecules, according to some embodiments, which may be functionalized to one or more electrodes in a device such as that shown in FIG. 1a.

FIG. 2 illustrate a plurality of graphs which represent real-time trace of different analytes using imidazole reader molecule in −0.5V, 2 pA tunnel condition, according to some embodiments.

FIG. 3 illustrates a spectra of D-glucose using different reader molecules in the −0.5 V, 2 pA tunneling condition, according to some embodiments.

FIG. 4 are illustrative structures of two closely related carbohydrate isomers of D-Glucose (structure on left), and D-galactose (structure on the right).

FIGS. 5A-B, are graphs of generated recognition tunneling signals from D-glucose (FIG. 5A), and D-galactose (FIG. 5B), according to some embodiments.

FIG. 6 are illustrative structures of deoxyribose and ribose.

FIGS. 7A-D are graphs of recognition tunneling signals generated by the detecting device according to some embodiments, with FIGS. 7A, B representing D-ribose, FIG. 7C, D representing 2-deoxy-D-ribose. FIGS. 7A, C show signals over a first time period of one second, while FIGS. 7B, D show the signals over a 50 s time period.

FIGS. 8 and 9 represent systems for at least one of conducting analysis of carbohydrates, collecting data from such analysis, and analyzing data from such analysis, such analysis of data including SVM analysis and the like for removing background signals and qualifying and quantifying signal data, as well as including, in some embodiments, for comparing refined (and/or raw) signal data to stored signature signal data for one or more carbohydrates.

### DETAILED DESCRIPTION

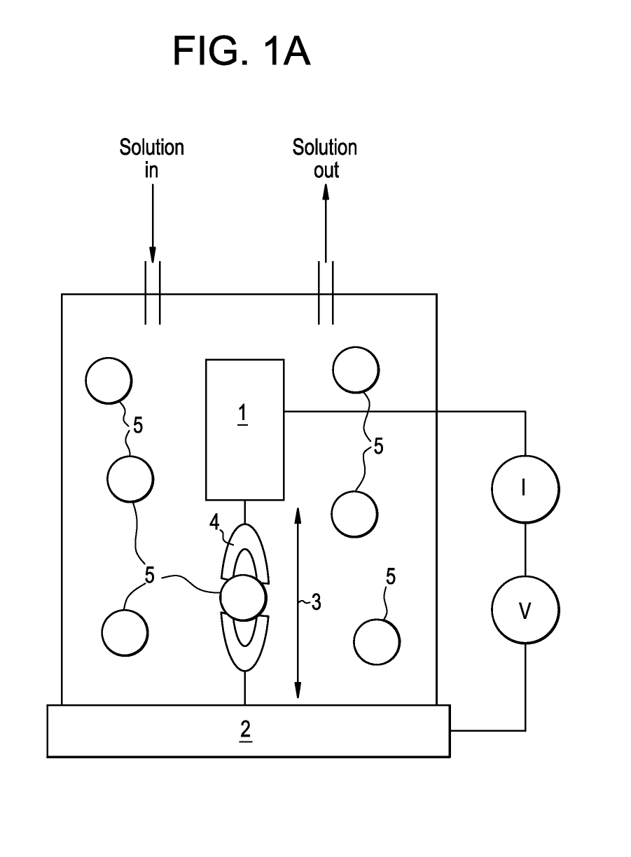

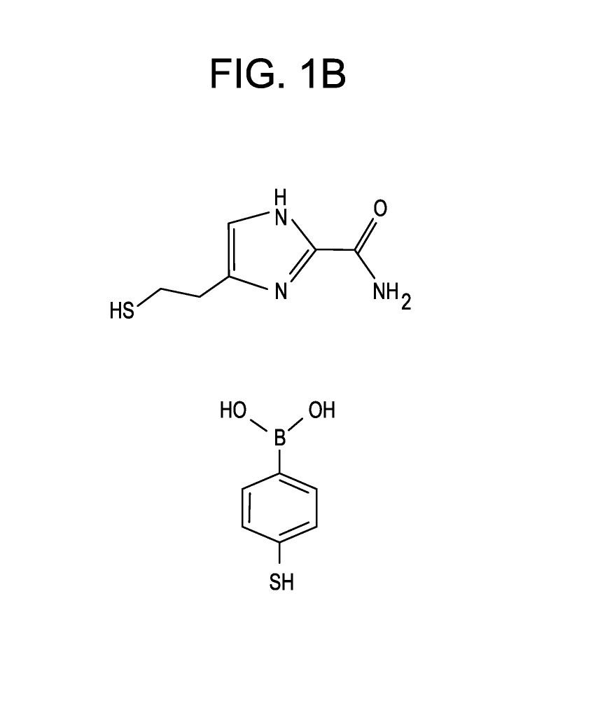

Reading carbohydrates electronically. In some embodiments of the present disclosure, individual monosaccharides of glycans may be identified electronically. FIG. 1a shows an exemplary embodiment which may be used to collect tunneling signals (see paragraph [0004], “Recognition Tunneling” and associated incorporated by reference documents). In such embodiments, for example, two opposed electrodes, 1 and 2, are separated by a gap 3 of about 2.5 nm (for example). Each electrode may be functionalized with a recognition reagent 4 that is chemically-bonded to the electrodes, and forms non-covalent bonds with the target molecule.

FIG. 1b shows that the structures of recognition molecules where the SH group is an anchoring group to from a bond with the metal electrode. Suitable metals according to some embodiments include, for example, platinum, palladium and gold.

As shown in FIG. 1a, in some embodiments, the entire system may be immersed in an aqueous electrolyte in a microfluidic chamber, for example. For the data presented in the present disclosure, the buffer comprises about 1 mM phosphate buffer, pH=7.4. In some embodiments, provided that only (sub-micron)² areas of one of the two electrodes are exposed to electrolyte, electrochemical leakage currents may be much less than tunnel current between the two electrodes. The gap, 3 may be defined by the current, I and the voltage V. For a voltage V of about 0.5V, for example, applied between the two electrodes, a current of about 2 pA, for example, is indicative of a gap of about 2.5-3 nm (for example). To that end, the data reported here is with respect to these exemplary conditions.

### Example 1

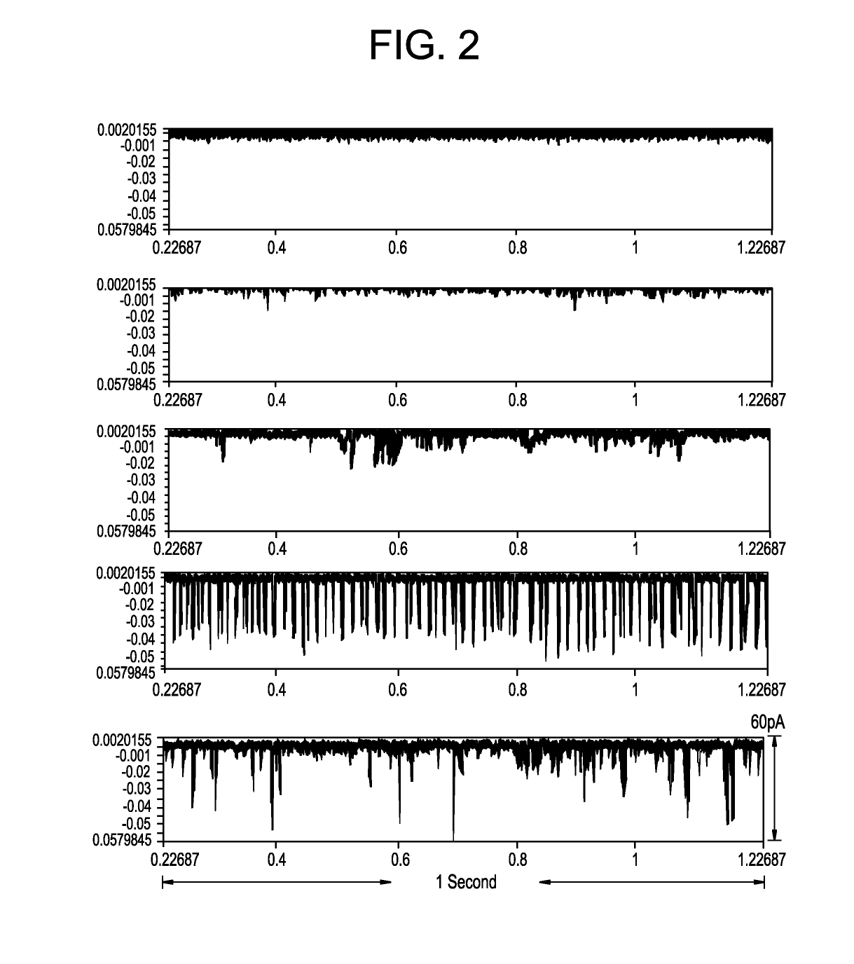

For example, in some embodiments, the device may be first functionalized with 4(5)-(2-mercaptoethyl)-1H imideazole-2-carboxamide, and then tested with three sugars: glucose, ribose, and deoxyribose, respectively. In the data collected, these sugar solutions were made with a concentration of 10 micromolar (for example). Accordingly, each sugar generated a distinguishable tunneling spectrum (as shown in FIG. 2). In the experiment according to such embodiments, a blank buffer solution was used as a negative control and a dAMP solution as a positive control.

To that end, the spectra were analyzed by a Support Vector Machine (SVM), the analysis of which provided an indication that each of these four molecules (D-glucose, 2-deoxyribose, ribose, and dAMP) may be effectively distinguished with a true-positive rate of assignment of individual signal peaks of about 82%, for example.

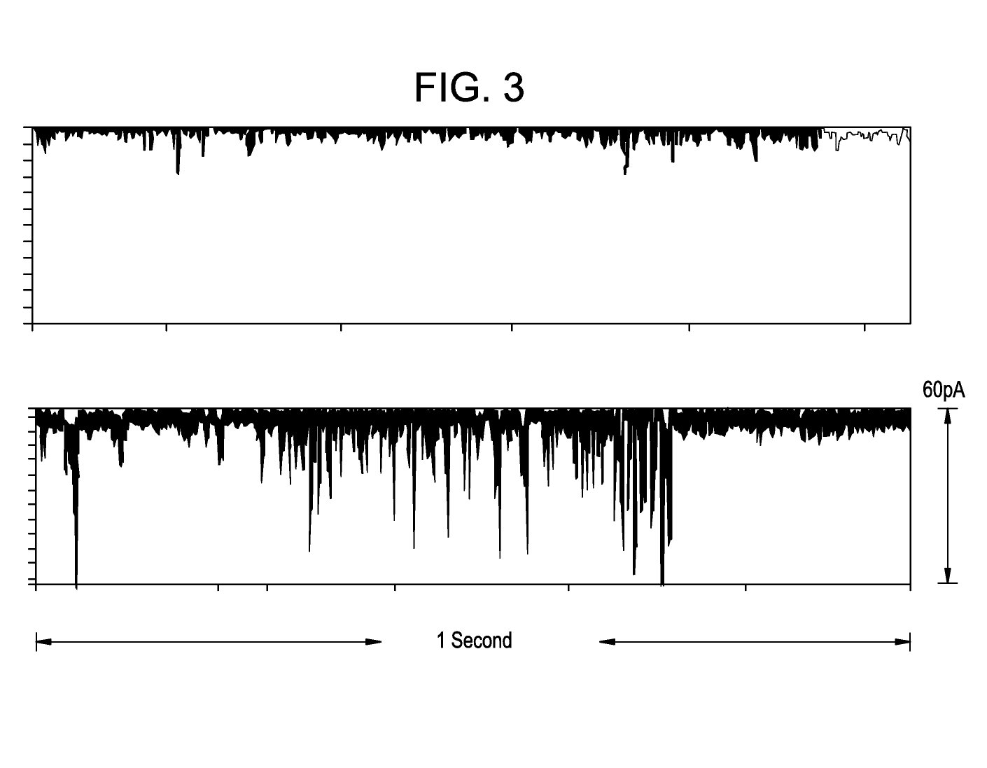

In some embodiments, the device was also functionalized with 4-mercaptophenylboronic acid, which resulted in data, for example, indicative that phenylboronic acid recognized glucose more effectively than the imidazole-2-carboxamide with a larger current signal (see FIG. 3).

### Example 2

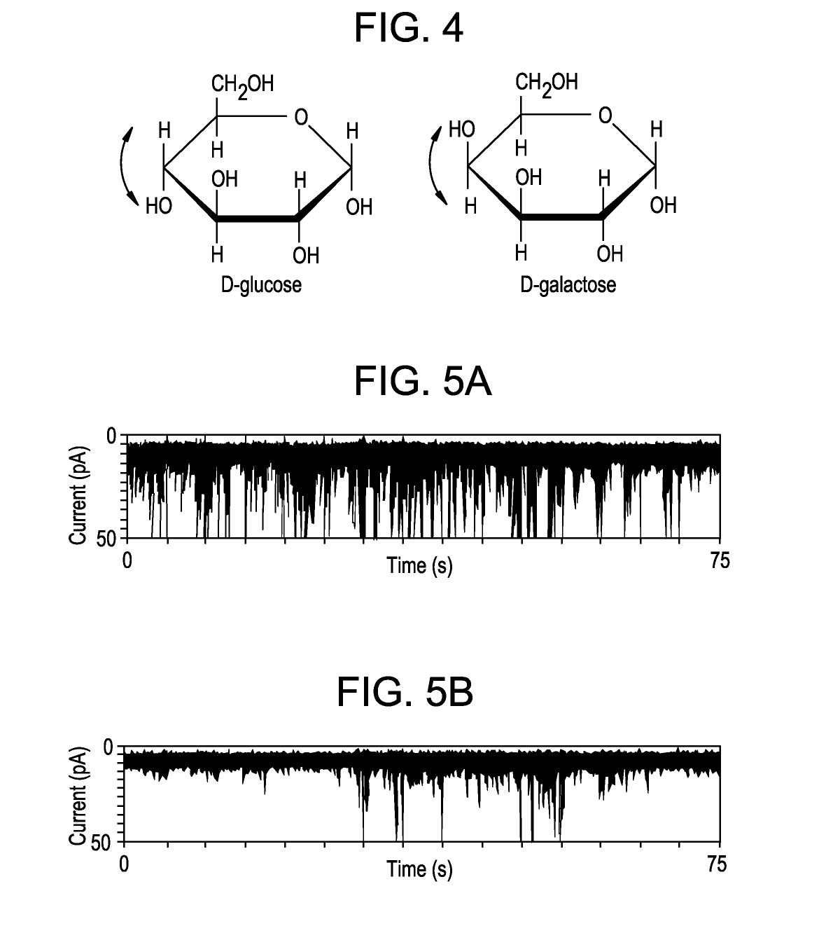

The ability of recognition tunneling to distinguish closely related sugars was tested using D-glucose and D-galactose with respect to some embodiments. The structure of these isomers is shown in FIG. 4. These isomers are identical in composition and differ only in the positioning of an OH group on the alcohol containing side of the ring (galactose) as opposed to the side opposite the alcohol moiety (glucose). Despite this small difference, there are differences in the recognition tunneling signals generated by these two molecules (as shown in FIG. 4). Specifically, in some embodiments, glucose provides a larger and more frequent signal

One of skill in the art will appreciate that since recognition tunneling signals contain much more information than just the amplitude and frequency of the signals spikes, the signals are best separated using a machine learning algorithm, the support vector machine, as taught, for example, by Chang et al. (2012) for the case of the DNA bases. Accordingly, with respect to the present teachings, the SVM was trained on a small fraction (e.g., about 10%) of the signal train from each of the two isomers and then tested using the remainder of the signal train. The results are summarized in Table 1.

TABLE 1
SVM Analysis Result for differentiation between D-glucose and
D-galactose.

| | Set-point | | | | |
|---|---|---|---|---|---|
| Tunneling | Conductance | Recognized | Total | Useful | True positive |
| Conditions | (pS) | Peaks | Peaks | Peaks | rate |
| -0.5 V 2 pA | 4 | 890 | 1272 | 70.0% | 94.9% |
| -0.5 V 4 pA | 8 | 2294 | 3122 | 73.5% | 95.2% |

At each of the two tunneling set points, with the conductances chosen (e.g., 4 pS and 8 pS) about 70% of the signal peaks were recognized using the support vectors developed by the training. Of the fraction recognized, 95% were called correctly on each peak, the remaining 5% being called as the wrong isomer.

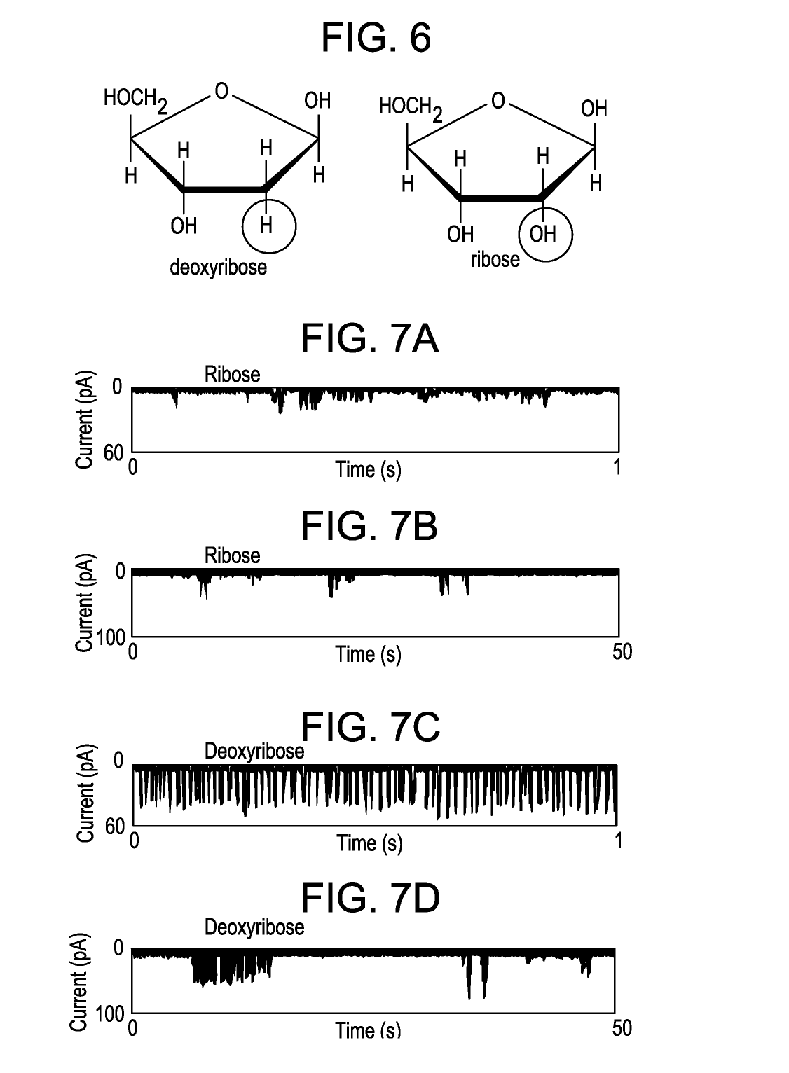

The technique, according to some embodiments, was tested further using solutions of D-ribose and 2-deoxy-D-ribose (FIG. 6). These sugars differ only by one oxygen atom (circled on FIG. 6). Typical recognition tunneling signals for this pair of analytes are shown in FIG. 7. The recognition tunneling signals are different, as shown on two time scales (A,C 1 s, B,D 50 s). The deoxyribose sugar gives larger, more frequent signals. The shape of the signal spikes from deoxyribose is shows greater regularity. The shape of the signals may then be analyzed using the support vector machine described by Chang et al (2012). A SVM analysis of the signals form these two sugars is shown in Table 2.

TABLE 2

| | Set-point | | | | |
|---|---|---|---|---|---|
| Tunneling | Conductance | Recognized | Total | Useful | True positive |
| Conditions | (pS) | Peaks | Peaks | Peaks | rate |
| -0.5 V 2 pA | 4 | 3337 | 4118 | 81.0% | 92.7% |
| -0.5 V 4 pA | 8 | 2577 | 3391 | 76.0% | 92.1% |

This example of the SVM results in about 80% of the signal peaks being recognized after training on 10% of the data. The true positive rate for assignment of each peak exceeds 90%

Various implementations of the embodiments disclosed above (e.g., carbohydrate identification), in particular at least some of the processes discussed, may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Such computer programs (also known as programs, software, software applications or code) include machine instructions for a programmable processor, for example, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor and the like) for displaying information to the user and a keyboard and/or a pointing device (e.g., a mouse or a trackball) by which the user may provide input to the computer. For example, this program can be stored, executed and operated by the dispensing unit, remote control, PC, laptop, smart-phone, media player or personal data assistant (“PDA”). Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Certain embodiments of the subject matter described herein may be implemented in a computing system and/or devices that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system according to some such embodiments described above may include clients and servers. A client and server are generally remote from each other and typically interact through a communication network. The relationship of client and server arises by virtue of computer programs running on the respective computers and having a client-server relationship to each other.

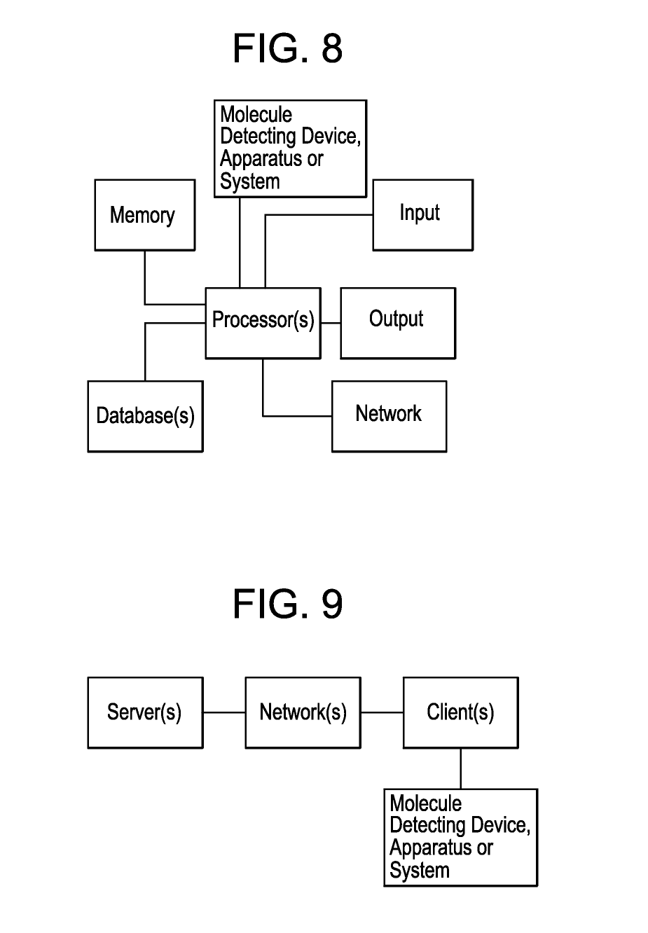

For example, as shown in FIG. 8, such a system may include at least one molecule detecting/identification device which is in communication (wired or wireless) with at least one controller/processor. The processor communicates with at least one database, which may store signatures for various carbohydrates, as well as collected data from runs of carbohydrates. The processor may include computer instructions operating thereon for accomplishing any and all of the methods and processes disclosed in the present disclosure, including comparing collected current spike data to signatures stored in the database. Input/output means may also be included, and can be any such input/output means known in the art (e.g., display, memory, database, printer, keyboard, microphone, speaker, transceiver, and the like). Moreover, in some embodiments, the processor and at least the database can be contained in a personal computer or client computer which may operate and/or collect data from the detecting device. The processor also may communicate with other computers via a network (e.g., intranet, internet). The system may also be used to collect and store current signals of carbohydrates being identified/sequenced, and in particular, current signals vs. time.

Similarly, FIG. 9 illustrates a molecule detecting/identification system according to some embodiment which may be established as a server-client based system, in which the client computers are in communication with detecting devices. The client computer(s) may be controlled by a server(s), each of which may include the database for storing current signatures of carbohydrates, and also be used to collect data (e.g., either or both may include the database). The client computers communicate with the server via a network (e.g., intranet, internet, VPN). Each detecting device may each be connected to a dedicated client. Similar to the system in FIG. 8, the client-server based system may also be used to collect and store current signals of carbohydrates being identified/detecting, and in particular, current signals vs. time. Also, the detecting device, if it includes appropriate hardware and software, may be in communication directly with the network(s) and/or server(s).

Any and all references to publications or other documents, including but not limited to, patents, patent applications, articles, webpages, books, etc., presented in the present application, are herein incorporated by reference in their entirety.

Although a few variations have been described in detail above, other modifications are possible. For example, any logic flow depicted in the accompanying figures and described herein does not require the particular order shown, or sequential order, to achieve desirable results. Other implementations may be within the scope of at least some of the following exemplary claims.

Example embodiments of the devices, systems and methods have been described herein. As noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to carbohydrate detection. In other words, elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure).

### REFERENCE CITED AND HEREIN INCORPORATED BY REFERENCE IN THEIR ENTIRETIES

1. C. T. Campbell and K. J. Yarema, Genome biology 6 (11), 236 (2005).
2. Z. Zhang and R. J. Linhardt, Current Analytical Chemistry 5, 225-237 (2009).
3. M. Ly, F. E. L. III, T. N. Laremore, T. Toida, J. Amster and R. J. Linhardt, Nature Chemical Biology 7, 827-833 (2011).
4. L. Liu, J. E. Telford, A. Knezevic and P. M. Rudd, Biochem Soc Trans 38 (5), 1374-1377 (2010).

### OTHER REFERENCES PERTAINING TO AT LEAST SOME OF EMBODIMENTS OF THE PRESENT DISCLOSURE ARE HEREIN INCORPORATED BY REFERENCE IN THEIR ENTIRETIES

Huang, S.; He, J.; Chang, S.; Zhang, P.; Liang, F.; Li, S.; Tuchband, M.; Fuhrman, A.; Ros, R.; Lindsay, S. M., Identifying single bases in a DNA oligomer with electron tunneling. Nature Nanotechnology 2010, 5, 868-73.
Lindsay, S.; He, J.; Sankey, O.; Hapala, P.; Jelinek, P.; Zhang, P.; Chang, S.; Huang, S., Recognition Tunneling. Nanotechnology 2010, 21, 262001-262013.
Liang, F.; Li, S.; Lindsay, S.; Zhang, P., Chemical and Hydrogen Bonding Properties of Imidazole-2-carboxamide, a reagent for DNA Sequencing by Recognition Tunnelling Chemistry 2011, submitted.
Lawson, J. W.; Bauschlicher, C. W., Transport in Molecular Junctions with different molecular contacts. Physical Review B 2006, 74, 125401.
Chang, S.; He, J.; Zhang, P.; Gyarfas, B.; Lindsay, S., Analysis of Interactions in a Molecular Tunnel Junction. J. Am Chem Soc 2011, 133, 14267-14269.
Hempel, J., An orientation to Edman chemistry. In Modern Protein Chemisty, Howard, G. C.; Brown, W. E., Eds. CRC Press: 2002; pp 103-122.
Chang, S., S. Huang, H. Liu, P. Zhang, R. Akahori, S. Li, B. Gyarfas, J. Shumway, B. Ashcroft, J. He, and S. Lindsay, Chemical Recognition and Binding Kinetics in a Functionalized Tunnel Junction. Nanotechnology, 2012.
Chang, C.-C. and C.-J. Lin, LIBSVM: a library for support vector machines. ACM Transactions on Intelligent Systems and Technology, 2011: p. 2:27:1-27:27.
Chen, W., X. Yin, J. Q. Mu, and Y. Yin, Subfemtomole level protein sequencing by Edman degradation carried out in a microfluidic chip. Chem. Commun., 2007: p. 2488-2490.
Chen, W., J. Shen, X. Yin, and Y. Yin, Optimization of microfabricated nanoliter-scale solid-phase extraction device for detection of gel-separated proteins in low abundance by matrix assisted laser desorption/ionization mass spectrometry. Rapid Communications in Mass Spectrometry, 2007. 21: p. 35-43.
Tuchband, M., J. He, S. Huang, and S. Lindsay, Insulated gold scanning tunneling microscopy probes for recognition tunneling in an aqueous environment. Rev, Sci. Instrum., 2012. 83: p. 015102.

What is claimed is:

1. A device for detecting, sequencing and/or otherwise identifying one or more carbohydrates, the device comprising:
two opposed electrodes, wherein each of said electrodes is functionalized with a molecule bonded to said electrodes, and wherein said molecule forms non-covalent bonds with target carbohydrate;
voltage applying means for applying a voltage between the two electrodes;
current detecting means for detecting a current passing between the two electrodes, wherein a detected current comprises a signal.

2. The device of claim 1, further comprising translating means for translating characteristics of each signal into corresponding structures of one or more carbohydrates as they pass between said electrodes.

3. The device of claim 1, wherein the molecule is 4(5)-(2-mercaptoethyl)-1H imideazole-2-carboxamide.

4. The device of claim 1, wherein the molecule is mercaptophenylboronic acid.

5. The device of claim 1, wherein the molecule is any molecule containing carboxamide.

6. The device of claim 1, wherein the carbohydrates are isobaric isomers.

7. A method for detecting, sequencing and/or otherwise identifying one or more carbohydrates, the method, comprising:
providing a recognition tunneling device, said device comprising:
two opposed electrodes, wherein each of said electrodes is functionalized with a molecule that is bonded to said electrodes, and wherein said molecule forms non-covalent bonds with target carbohydrate;
voltage applying means for applying a voltage between the two electrodes;
current detecting means for detecting a current passing between the two electrodes, wherein a detected current comprises a signal;
translating means for translating characteristics of each signal into corresponding structures of one or more carbohydrates as they pass between said electrodes; and
flowing a fluid containing one or more carbohydrates between the two electrodes of the recognition tunneling device, wherein fluid flow is accomplished via at least one of a pressure gradient, electroosmosis, and electrophoresis;
recording current signals generated as the fluid flows through the gap which is representative of the at least carbohydrates; and
determining the one or more carbohydrates based on the signals.

8. A device for detecting, sequencing and/or otherwise identifying one or more carbohydrates, the device comprising:
means for detecting electronic signals from individual molecules by measuring current signals as a voltage is applied across a junction in which said molecules are transiently trapped
means for recording said electronic signals and parameterizing the current as a function of time
and means for identifying the electronic signals based on training a machine-learning program.

9. A computer system for detecting, sequencing and/or otherwise identifying at least one carbohydrate, the system comprising at least one processor, wherein the processor includes computer instructions operating thereon for performing a method for sequencing or otherwise identifying at least one carbohydrate according to any of claims 7 and 12-14.

10. A computer program for detecting, sequencing and/or identifying at least one carbohydrate, comprising computer instructions for operation on a computer for performing a method for detecting, sequencing or otherwise identifying at least one carbohydrate according to any of claims 7 and 12-14.

11. A computer readable medium containing a program, wherein the program includes computer instructions for operation on a computer for performing a method for detecting, sequencing or otherwise identifying at least one carbohydrate according to any of claims 7 and 12-14.

12. A method for detecting, sequencing and/or otherwise identifying one or more carbohydrates, the method, comprising:
flowing a fluid containing at least one carbohydrate between the two electrodes of a recognition tunneling device, wherein fluid flow is accomplished via at least one of a pressure gradient, electroosmosis, and electrophoresis;
recording current signals generated as the fluid flows through the gap which is representative of the at least carbohydrates; and
determining the one or more carbohydrates based on the signals.

13. The method of claims 7 or 12, wherein determining comprises comparing the signals to carbohydrate signature signals stored in a memory or database.

14. The method of claims 7, 12 or 13, wherein determining includes analysis of the signals to remove background signals and/or other non-relevant signals and/or data.
